(19) United States
(12) Patent Application Publication
(10) Pub. No.: US 2025/0145532 A1
(43) Pub. Date: May 8, 2025

(54) ALUMINA-BASED FUSED GRAIN

(71) Applicant: SAINT-GOBAIN CENTRE DE RECHERCHES ET D' ETUDES EUROPEEN, COURBEVOIE (FR)

(72) Inventor: Nadia FREDERICH, L'ISLE-SUR-LA-SORGUE (FR)

(21) Appl. No.: 18/721,186

(22) PCT Filed: Dec. 15, 2022
(86) PCT No.: PCT/EP2022/086096

§ 371 Date: Jun. 17, 2024

(30) Foreign Application Priority Data
Dec. 15, 2021 (FR) FR2113564

(51) Int. Cl. C04B 35/107; C04B 35/626; C04B 35/64; C04B 35/653

(52) U.S. Cl. CPC C04B 35/107; C04B 35/6262; C04B 35/64; C04B 35/653; C04B 2235/3201; C04B 2235/3206; C04B 2235/3222; C04B 2235/3243; C04B 2235/3418; C04B 2235/656; C04B 2235/663; C04B 2235/721; C04B 2235/87

(57) ABSTRACT

A fused grain is provided with the following chemical composition, expressed in weight percent on the basis of the oxides: MgO: 2.5% to 5.8%; Cr₂O₃: 0.2% to 4.5%; oxides other than MgO, Cr₂O₃ and Al₂O₃: ≤1.5%; Al₂O₃: remainder up to 100%.

### TECHNICAL FIELD

The present invention relates to a fused grain based on alumina, to a mixture of said grains and also to a process for manufacturing said grains and to an abrasive tool comprising said mixture of grains. The invention also relates to uses of grains according to the invention for abrading steel surfaces.

### PRIOR ART

Abrasive tools are generally classified according to the method of conditioning their abrasive grains: free abrasives (powders of the grains, not attached to a backing, used in spraying or in suspension), coated abrasives (cloth or paper backing, on which the grains are positioned in several layers) and bonded abrasives (circular grinding wheels, sticks, etc.).

In bonded abrasives, the abrasive grains are pressed with an organic or glassy binder, conventionally a binder composed of oxides which is essentially silicated. The abrasive grains must themselves have good mechanical abrasion properties and have good mechanical cohesion with the binder, i.e. the interface must be solid.

Among the abrasive grains, a distinction is made between fused grains and sintered grains, which have different microstructures. The problems posed by sintered grains and by fused grains, and the technical solutions adopted to solve them, are therefore generally different. A composition developed for manufacturing a fused grain is therefore not a priori usable for manufacturing a sintered grain having the same properties, and vice versa.

WO2004094554 describes aluminous fused grains comprising between 1.5% and 6.5% of MgO, as a weight percentage based on the oxides.

U.S. Pat. No. 2,279,260 describes aluminous fused grains comprising more than 8% by weight of Cr203. To limit the formation of spinel in grains, the presence of more than 2% MgO requires the presence of at least one acid oxide such as SiO₂, TiO₂, ZrO₂ or B₂O₃.

There is therefore an ongoing need to improve the performance of alumina-based fused grains, and in particular to:
increase the efficacy while maintaining an energy efficiency, in an application where the fused grains are used as abrasives, greater than or substantially equal to that of grains of the prior art, or
equivalently, to increase said energy efficiency while maintaining an efficacy greater than or substantially equal to that of grains of the prior art.

One aim of the invention is to meet this need, at least partially.

### SUMMARY OF THE INVENTION

According to the invention, this aim is achieved by means of a fused grain, which is optionally calcined, having the following chemical analysis, as weight percentages based on the oxides:
MgO: 2.5% to 5.8%;
Cr₂O₃:0.2% to 4.5%;
oxides other than MgO, Cr₂O₃ and Al₂O₃: ≤1.5%;
Al₂O₃: balance to 100%.

As will be seen in greater detail in the remainder of the description, the inventors have discovered that the above chemical composition confers an efficacy and/or an energy efficiency greater than those of known alumina fused grains.

A fused grain according to the invention can also have one or more of the following optional characteristics:
MgO≥2.7%, preferably MgO≥2.9%, preferably MgO≥3.1%, preferably MgO≥3.5%, preferably MgO≥4.0%, and/or preferably MgO≤5.5%, preferably MgO≤5.2%, preferably MgO≤5.1%, preferably MgO≤5%, as weight percentages based on the oxides;
Cr₂O₃≥0.3%, preferably Cr₂O₃>0.35%, preferably Cr₂O₃>0.4%, preferably Cr₂O₃≥0.7%, preferably Cr₂O₃≥1.0%, and/or Cr₂O₃≤4.0%, preferably Cr₂O₃≤3.5%, preferably Cr₂O₃≤3.0%, preferably Cr₂O₃≤2.7%, preferably Cr₂O₃≤2.5%, preferably Cr₂O₃≤2.2%, preferably Cr₂O₃≤2%, as weight percentages based on the oxides;
the content of oxides other than MgO, Cr₂O₃ and Al₂O₃ is less than 1.4%, preferably less than 1.3%, preferably less than 1.0%, preferably less than 0.9%, preferably less than 0.8%, preferably less than 0.7%, preferably less than 0.6%, preferably less than 0.5%, preferably less than 0.4%, as weight percentages based on the oxides;
Na₂O≤0.3%, preferably Na₂O≤0.1%, as weight percentages based on the oxides;
SiO₂≤0.3%, preferably SiO₂≤0.1%, as weight percentages based on the oxides;
the carbon content is greater than 20 ppm, preferably greater than 50 ppm, preferably greater than 100 ppm, and/or less than 0.5%, preferably less than 0.3%, preferably less than 0.15%, preferably less than 0.1%, s weight percentages based on the weight of the fused grain;
the release of hydrogen gas by hot acid etching is greater than 15 cm³/100 g, preferably greater than 30 cm³/100 g, preferably greater than 50 cm³/100 g, and/or less than 500 cm³/100 g, preferably less than 400 cm³/100 g, preferably less than 300 cm³/100 g, preferably less than 200 cm³/100 g;
the content of oxide compounds is greater than 96%, preferably greater than 97%, as weight percentages based on the weight of the fused grain;
the fused grain has a microstructure substantially composed of alumina crystals, said crystals being separated by boundaries, located in which is the element Cr, at least partially in metallic form, and preferably
for a mixture consisting of said grains, the release of hydrogen gas by hot acid etching, expressed as volume of gas per 100 grams of grains, is greater than 15 cm³/100 g and less than 500 cm³/100 g, and/or
said grain has a carbon content of greater than 20 ppm and less than 0.4%, as weight percentages based on the weight of said fused grain;
the fused grain has a microstructure substantially composed of alumina crystals, said crystals being separated by boundaries, located in which is MgO, preferably substantially entirely in non-stoichiometric and/or stoichiometric MgAl₂O₄ spinel form, and/or in non-stoichiometric and/or stoichiometric MgCr₂O₄ spinel form, at least a portion of the element Cr, preferably in Cr³⁺ form, being inserted into the crystal lattice of the alumina crystals, and preferably
for a mixture consisting of said grains, the release of hydrogen gas by hot acid etching, expressed as volume of gas per 100 grams of grains, is less than 15 cm³/100 g, and/or
said grain has a carbon content of less than 500 ppm, as weight percentages based on the weight of said fused grain.

In particular embodiments:
MgO≥2.9% and MgO≤5.5% and Cr₂O₃≥0.3% and Cr₂O₃≤4.0%, and the content of oxides other than MgO, Cr₂O₃ and Al₂O₃ is less than 1.3%;
MgO≥3.1% and MgO≤5.2% and Cr₂O₃>0.4% and Cr₂O₃≤3.5%, and the content of oxides other than MgO, Cr₂O₃ and Al₂O₃ is less than 1.0%;
MgO≥3.5% and MgO≤5.1% and Cr₂O₃≥ 0.7% and Cr₂O₃≤3.0%, and the content of oxides other than MgO, Cr₂O₃ and Al₂O₃ is less than 0.5%;
MgO≥4.0% and MgO≤5.0% and Cr₂O₃≥1.0% and Cr₂O₃≤2.5%, and the content of oxides other than MgO, Cr₂O₃ and Al₂O₃ is less than 0.4%;

the content of oxide compounds each time being greater than 96%, preferably greater than 97%, as weight percentages based on the weight of the fused grain.

In one particular embodiment, a fused grain according to the invention has the following chemical analysis, as weight percentages based on the weight of the oxides:
MgO: 2.5% to 5.5%;
Cr₂O₃:0.2% to 3%;
oxides other than MgO, Cr₂O₃ and Al₂O₃:≤1%;
Al₂O₃:balance to 100%.

The invention also relates to a mixture of grains comprising, as a weight percentage, more than 80% of fused grains according to the invention.

The invention also relates to a process for the manufacture of a mixture of fused grains according to the invention, said process comprising the following successive steps:
a) mixing of raw materials so as to form a feedstock suitable for the manufacture of said mixture of grains,
b) melting said feedstock in a reducing medium until a molten material is obtained,
c) cooling said molten material so as to fully solidify it in less than 3 minutes, and obtain a solid mass,
d) optionally, and in particular if step c) does not result in grains being obtained, milling said solid mass,
e) optionally, particle size selection.

The element Cr is not conventionally introduced, as an impurity in the Mg or Al sources, in sufficient amounts for its content, in the fused grain, to exceed 0.2%. Preferably, the element Cr is introduced deliberately, preferably by controlled addition, into the feedstock, preferably by addition of a powder having a Cr₂O₃ content of greater than 90%, preferably greater than 95% by weight.

The manufacturing process according to the invention can also have one or more of the following optional characteristics:
the process comprises, after step c), preferably after step d) if the process comprises a step d), and preferably after step e) if the process comprises a step e), a step f) of calcining the mixture of grains produced, the calcination preferably being in an oxidizing atmosphere, preferably at a temperature above 800° C. and preferably below 1700°° C., the maximum temperature reached during the calcination preferably being maintained for a period of at least 30 minutes;
in one embodiment, the calcination is carried out in an oxidizing atmosphere and at a temperature above 1280° C. and preferably below 1700°° C., the maximum temperature reached during calcination preferably being maintained for a period of at least 30 minutes; the calcined fused grains obtained then have a microstructure substantially composed of alumina crystals, said crystals being separated by boundaries, located in which is MgO, preferably substantially entirely in non-stoichiometric and/or stoichiometric MgAl₂O₄ spinel form, and/or in non-stoichiometric and/or stoichiometric MgCr₂O₄ spinel form, at least a portion of the element Cr, preferably in Cr³⁺ form, being inserted into the crystal lattice of the alumina crystals; when the fused grains obtained before step f) are according to the preferred embodiments described above, the maximum release of hydrogen gas by hot acid etching, expressed as volume of gas per 100 grams of grains, is then less than 15 cm³/100 g and/or the calcined fused grains have a carbon content of less than 500 ppm, as weight percentages based on the weight of the fused grain;
the process comprises, after step c), preferably after step d) if the process comprises a step d), and preferably after step e) if the process comprises a step e), a calcination step f), preferably in an oxidizing atmosphere, at a temperature preferably above 800° C. and below or equal to 1280° C., the maximum temperature reached during the calcination preferably being maintained for a period of at least 30 minutes; the calcined fused grains obtained then have a microstructure substantially composed of alumina crystals, said crystals being separated by boundaries, located in which is the element Cr, at least partially in metallic form; when the fused grains obtained before step f) are according to the preferred embodiments described above, the release of hydrogen gas by hot acid etching, expressed as volume of gas per 100 grams of grains, is greater than 15 cm³/100 g and less than 500 cm³/100 g, and/or the calcined fused grains have a carbon content of greater than 30 ppm and less than 0.4%, as weight percentages based on the weight of the fused grain.

In one embodiment, the process does not comprise, after step c), or after step d) or after step e), a step f) of calcination at a temperature above 800° C. and below 1700° C. In other words, the grains are used as abrasive, and in particular bound by a binder and agglomerated or deposited on a backing so as to form an abrasive tool without having been calcined.

The invention also relates to an abrasive tool comprising grains bound by a binder and bonded, for example in the form of a grinding wheel, or deposited on a backing, for example a belt or disk, this tool being noteworthy in that at least a portion, preferably more than 50%, preferably more than 70%, preferably more than 80%, preferably more than 90%, preferably more than 95%, preferably more than 99%, as weight percentages, and preferably all, of said grains are in accordance with the invention.

The abrasive tool may in particular be a truing grinding wheel, a precision grinding wheel, a sharpening grinding wheel, a cut-off grinding wheel, a grinding wheel for machining from the body, a fettling or roughing grinding wheel, a regulating grinding wheel, a portable grinding wheel, a foundry grinding wheel, a drill grinding wheel, a mounted grinding wheel, a cylinder grinding wheel, a cone grinding wheel, a disk grinding wheel or a segmented grinding wheel or any other type of grinding wheel.

In general, the invention relates to a process for treating a surface, preferably made of steel, said process comprising an operation of abrading said surface with a mixture of grains according to the invention or manufactured according to a process according to the invention.

Preferably, the process comprises:
manufacturing a mixture of grains according to the invention, preferably according to a manufacturing process according to the invention, then
an operation of abrading said surface with said mixture of grains, preferably in the form of an abrasive tool according to the invention.

The grains according to the invention are particularly recommended for the machining of steel, in particular stainless steels and hard steels.

In one embodiment, the surface is made of a hard steel and said fused grains of said mixture have a microstructure substantially composed of alumina crystals, said crystals being separated by boundaries, located in which is the element Cr, at least partially in metallic form, preferably having a release of hydrogen gas by hot acid etching, expressed as volume of gas per 100 grams of grains, of greater than 15 cm³/100 g and less than 500 cm³/100 g, and/or a carbon content of greater than 20 ppm and less than 0.4%, preferably less than 500 ppm, as weight percentages based on the weight of the fused grain, and/or were manufactured according to a process comprising a calcination step f) at a calcination temperature below or equal to 1280°° C., preferably carried out in an oxidizing atmosphere. Preferably, said fused grains are according to the first particular embodiment described in detail below.

In one embodiment, the surface is made of a stainless steel and the calcined fused grains obtained then have a microstructure substantially composed of alumina crystals, said crystals being separated by boundaries, located in which is MgO, preferably substantially entirely in non-stoichiometric and/or stoichiometric MgAl₂O₄ spinel form, and/or in non-stoichiometric and/or stoichiometric MgCr₂O₄ spinel form, at least a portion of the element Cr, preferably in

Cr³⁺ form, being inserted into the crystal lattice of the alumina crystals, preferably having a release of hydrogen gas by hot acid etching, expressed as volume of gas per 100 grams of grains, of less than 15 cm³/100 g and/or having a carbon content of less than 500 ppm, as weight percentages based on the weight of the fused grains, and/or were manufactured according to a process comprising a calcination step f) at a calcination temperature above 1280° C., and preferably below 1700°° C., preferably carried out in an oxidizing atmosphere. Preferably, said fused grains are according to the second particular embodiment described in detail below.

### Definitions

The contents of oxides of a grain according to the invention, including for the “oxides other than MgO, Cr₂O₃ and Al₂O₃” relate to the overall contents for each of the corresponding chemical elements, expressed in the form of the most stable oxide, according to the standard convention of the industry; the suboxides and optionally nitrides, oxynitrides, carbides, oxycarbides, carbonitrides or even the metallic species of the abovementioned elements are thus included.

The term “impurities” means the unavoidable constituents necessarily introduced with the raw materials. In particular, the compounds that belong to the group of oxides, nitrides, oxynitrides, carbides, oxycarbides, carbonitrides and metallic species of sodium and other alkali metals, iron and vanadium are impurities. As examples, in the sources of Al and Mg, mention may be made of SiO₂, Fe₂O₃ or Na₂O.

A “precursor” of an oxide is understood to mean a constituent capable of providing said oxide during the manufacture of a grain or of a mixture of grains according to the invention.

A “grain” is a particle for which all dimensions are less than 20 mm.

An “alumina-based grain” refers to a grain comprising more than 85% by weight of alumina, as a percentage based on the oxides.

A “fused grain” or more broadly “fused product” is understood to mean a solid grain (or product) obtained by solidification by cooling of a molten material.

A “molten material” is a mass, rendered liquid by heating a feedstock, which may contain a few solid particles, but in an insufficient amount for them to be able to give structure to said mass. In order to retain its shape, a molten material has to be contained within a receptacle. The fused grains based on oxides according to the invention are conventionally obtained by melting at more than 1900° C.

The “median size” of a powder refers to the size dividing the particles into first and second populations that are equal by weight, these first and second populations comprising only particles having a size of greater than or equal to, or respectively less than, the median size. The median size of a powder can be determined using a particle size distribution produced using a laser particle sizer.

In the present description, unless otherwise mentioned, all the compositions of a grain are given as weight percentages, based on the total weight of the oxides of the grain.

### DETAILED DESCRIPTION

The description which follows is provided for illustrative purposes and does not limit the invention.

### Fused Grain

The chemical composition of a fused grain according to the invention, and preferably of a mixture of grains according to the invention, preferably has one or more of the following optional characteristics:
MgO≥2.7%, preferably MgO≥2.9%, preferably MgO≥3.1%, preferably MgO≥3.5%, preferably MgO>4.0%, and/or preferably MgO≤5.5%, preferably MgO≤5.2%, preferably MgO≤5%, as weight percentages based on the oxides;
Cr₂O₃≥0.3%, preferably Cr₂O₃>0.35%, preferably Cr₂O₃≥0.4%, preferably Cr₂O₃≥0.7%, preferably Cr₂O₃≥1.0%, and/or Cr₂O₃≤4.0%, preferably Cr₂O₃≤3.5%, preferably Cr₂O₃≤3.0%, preferably Cr₂O₃≤2.7%, preferably Cr₂O₃≤2.5%, preferably Cr₂O₃≤2.3%, preferably Cr₂O₃≤2.2%, preferably Cr₂O₃≤2%, as weight percentages based on the oxides;
the content of oxides other than MgO, Cr₂O₃ and Al₂O₃ is preferably less than 1.4%, preferably less than 1.3%, preferably less than 1.0%, preferably less than 0.9%, preferably less than 0.8%, preferably less than 0.7%, preferably less than 0.6%, preferably less than 0.5%, preferably less than 0.4%, as weight percentages based on the oxides;
the oxides other than MgO, Cr₂O₃ and Al₂O₃ are preferably impurities;
the Na₂O content is preferably less than 0.3%, preferably less than 0.25%, preferably less than 0.2%, preferably less than 0.15%, preferably less than 0.1%, as weight percentages based on the oxides;
the SiO₂ content is preferably less than 0.3%, preferably less than 0.2%, preferably less than 0.15%, preferably less than 0.1%, preferably less than 0.08%, preferably less than 0.05%, as weight percentages based on the oxides;
the content of oxide compounds is greater than 96%, preferably greater than 97%, preferably greater than 98%, or even greater than 99%, or even greater than 99.4%, or even greater than 99.5%, or even greater than 99.6%, or even greater than 99.7%, as weight percentages based on the weight of the fused grain;
in one embodiment, the fused grain is uncalcined and the carbon content is greater than 20 ppm, preferably greater than 30 ppm, preferably greater than 50 ppm, preferably greater than 100 ppm and/or preferably less than 0.5%, preferably less than 0.4%, preferably less than 0.3%, preferably less than 0.25%, preferably less than 0.2%, preferably less than 0.15%, preferably less than 0.1%, preferably less than 0.08%, as weight percentages based on the weight of the fused grain.

In one embodiment, the fused grain is calcined fused grain. The release of hydrogen gas by hot acid etching, expressed as volume of gas per 100 grams of fused grains, depends on the conditions under which the calcination of the fused grains was carried out. It is measured as described in detail in the examples.

In one embodiment, the fused grain is uncalcined and preferably is such that, for a mixture consisting of said grains, the release of hydrogen gas by hot acid etching, expressed as volume of gas per 100 grams of grains, is greater than 15 cm³/100 g, preferably greater than 30 cm³/100 g, preferably greater than 50 cm³/100 g, and/or preferably less than 500 cm³/100 g, preferably less than 400 cm³/100 g, preferably less than 300 cm³/100 g, preferably less than 200 cm³/100 g.

In a first particular embodiment, the fused grain has a microstructure substantially composed of alumina crystals, said crystals being separated by boundaries, located in which is the element Cr, at least partially in metallic form. Preferably, the oxides other than Al₂O₃, MgO and Cr₂O₃ are substantially entirely located in said boundaries.

Preferably, it is such that, for a mixture consisting of said grains, the release of hydrogen gas by hot acid etching, expressed as volume of gas per 100 grams of grains, is greater than 15 cm³/100 g, preferably greater than 30 cm³/100 g, preferably greater than 50 cm³/100 g, and preferably less than 500 cm³/100 g, preferably less than 400 cm³/100 g, preferably less than 300 cm³/100 g, preferably less than 200 cm³/100 g.

In this first particular embodiment, the fused grain preferably has a carbon content of greater than 20 ppm, preferably greater than 30 ppm, preferably greater than 50 ppm, preferably greater than 70 ppm, preferably greater than 100 ppm and preferably less than 0.4%, preferably less than 0.3%, preferably less than 0.2%, preferably less than 0.15%, preferably less than 0.1%, preferably less than 800 ppm, preferably less than 600 ppm, preferably less than 500 ppm, as weight percentages based on the weight of the fused grain.

The fused grain according to this first embodiment preferably has a chemical analysis having the same preferences as those described above, except for the carbon content and the release of hydrogen gas by hot acid etching.

The fused and calcined grains according to the first particular embodiment are preferably manufactured according to a process according to the invention comprising a calcination step f) preferably in an oxidizing atmosphere at a temperature preferably above 800° C., preferably above 900° C., and below or equal to 1280° C., preferably below 1200° C., preferably below 1150° C., preferably below 1100°° C., the maximum temperature reached during the calcination preferably being maintained for a period of at least 30 minutes, preferably at least 1 hour, preferably at least 2 hours.

The fused and calcined grains according to the first particular embodiment are particularly well suited for the machining of hard steels. The invention thus relates to an abrasion process according to the invention, in which fused and calcined grains according to the first particular embodiment are applied to surface made of hard steel, so as to abrade it.

In a second particular embodiment, the fused grain has a microstructure substantially composed of alumina crystals, said crystals being separated by boundaries, located in which is MgO, preferably substantially entirely in non-stoichiometric and/or stoichiometric MgAl₂O₄ spinel form, and/or in non-stoichiometric and/or stoichiometric MgCr₂O₄ spinel form, at least a portion of the element Cr, preferably in Cr³⁺ form, being inserted into the crystal lattice of the alumina crystals. Preferably, the oxides other than Al₂O₃, MgO and Cr₂O₃ are substantially entirely located in said boundaries.

Preferably, it is such that, for a mixture consisting of said grains, the release of hydrogen gas by hot acid etching, expressed as volume of gas per 100 grams of grains, is less than 15 cm³/100 g, preferably less than 10 cm³/100 g, preferably less than 5 cm³/100 g, preferably less than 1 cm³/100 g.

In this second particular embodiment, the fused grain preferably has a carbon content of greater than or equal to 0 ppm and less than 500 ppm, preferably less than 400 ppm, preferably less than 300 ppm, preferably less than 200 ppm, as weight percentages based on the weight of the fused grain.

The fused grain according to this second embodiment preferably has a chemical analysis having the same preferences as those described above, except for the carbon content and the release of hydrogen gas by hot acid etching.

The fused and calcined grains according to the second particular embodiment are preferably manufactured according to a process according to the invention comprising a calcination step f) in an oxidizing atmosphere at a temperature above 1280° C., preferably above 1300° C., and preferably below 1700° C., preferably below 1600° C., preferably below 1500° C., the maximum temperature reached during the calcination preferably being maintained for a period of at least 30 minutes, preferably at least 1 hour, preferably at least 2 hours.

The fused and calcined grains according to the second particular embodiment are particularly well suited for the machining of stainless steels. The invention thus relates to an abrasion process according to the invention, in which fused and calcined grains according to the second particular embodiment are applied to surface made of stainless steel, so as to abrade it.

A fused grain according to the invention therefore makes it possible, surprisingly, to obtain high-performance machining, both on hard steels and on stainless steels, in particular as a function of the calcination treatment applied thereto.

### Mixture of Grains

A mixture of grains according to the inventon comprises, as weight percentages, preferably more than 85%, preferably more than 90%, preferably more than 95%, preferably more than 99%, preferably substantially 100%, of fused grains according to the invention.

Preferably, a mixture of grains according to the invention complies with a particle size distribution in accordance with those of the mixtures or grits provided by the FEPA Standard 43-GB-1984, R1993 and the FEPA Standard 42-GB-1984, R1993.

Preferably, a grain mixture according to the invention has a weight oversize on a 16 mm screen, preferably on a 9.51 mm screen, measured using a Ro-Tap® sieve shaker, of less than 1%, as weight percentage.

Process for manufacturing a mixture of fused grains according to the invention

Fused grains according to the invention may be manufactured according to the abovementioned steps a) to e), which are conventional for the manufacture of fused alumina-based grains. The parameters may, for example, take the values of the process used for the examples below.

In step a), raw materials are conventionally metered out, so as to obtain the desired composition, and then mixed to form the feedstock.

The elements Al. Mg and Cr in the feedstock are found substantially in full in the fused grains. The elements Mg and Cr, especially in the form of oxides, can however be subject to fly-off phenomena during melting. A person skilled in the art knows how to consequently adjust the composition of the feedstock.

Choosing the raw materials of the feedstock so that the solid mass obtained at the end of step c) has a composition in accordance with that of a grain according to the invention thus does not present any difficulty to those skilled in the art.

The elements Mg and Cr are preferably introduced into the feedstock in the form of oxides MgO and Cr₂O₃. They can also be conventionally introduced in the form of precursors of these oxides, for example in the form of MgCO₃ and/or chromium hydroxide. The element Al is preferably at least partly introduced into the feedstock in the form Al₂O₃ and/or in the form of precursors of this oxide, for example in the form of aluminum hydroxide and/or boehmite. Preferably, the element Al is introduced into the feedstock partly in the form Al₂O₃ and partly in a metallic form.

In a preferred embodiment, the feedstock comprises compounds that create a reducing medium during melting.

Preferably, said compounds are chosen from a carbon source, a metal, and mixtures thereof. Preferably, the carbon source is selected from carbon, petroleum coke, pitch, coal and mixtures thereof, preferably petroleum coke. Preferably, the metal is aluminum.

More preferably, the compounds that create a reducing medium during melting and that are used in the feedstock are petroleum coke and aluminum.

A person skilled in the art knows how to determine the amount of compounds that create a reducing medium during melting, in the feedstock, in order to obtain, in step b), melting in a reducing medium.

Preferably, the feedstock contains an amount of compounds that create a reducing medium during melting of greater than 1%, preferably greater than 1.5% and preferably less than 5%, preferably less than 4%, by weight percentages based on the feedstock.

In step b), use is preferably made of an electric arc furnace, preferably of Héroult type with graphite electrodes, but any furnace known may be envisaged, such as an induction furnace or a plasma furnace, provided that they make it possible to melt the feedstock in a reducing medium.

Melting in a reducing medium is preferably obtained by the presence, in the feedstock, of compounds that create a reducing medium during melting and/or by the fact that the electrodes are immersed in the bath of molten material.

Preferably, the feedstock contains elements that create a reducing medium during melting.

Preferably, the raw materials are melted at atmospheric pressure.

Preferably, use is made of an electric arc furnace, comprising a vessel with a capacity of 70 liters, with a melting energy before casting of more than 2 kWh per kg of raw materials for a power of more than 220 kW, or an electric arc furnace with a different capacity used under equivalent conditions. A person skilled in the art knows how to determine such equivalent conditions.

In step c), the cooling has to be rapid, that is to say so that the molten material is completely solidified in less than 3 minutes. For example, it may result from casting into molds, as described in U.S. Pat. No. 3,993,119, or from a quenching.

Preferably, the molten material is completely solidified in less than 2 minutes, preferably in less than one minute, preferably in less than 40 seconds, preferably in less than 30 seconds.

If step c) does not make it possible to obtain a mixture of grains directly, or if these grains do not have a suitable particle size for the targeted application, milling (step d)) may be carried out, according to conventional techniques.

In step e), if the preceding steps do not make it possible to obtain a mixture of grains having a suitable particle size for the targeted application, a particle size selection, for example by screening or cycloning, may be carried out.

The process according to the invention preferably comprises a calcination step f), after step c), or preferably after step d) if the process comprises such a step, or preferably after step e) if the process comprises such a step.

The calcination temperature is adapted to the nature of the surface to be abraded, in particular when this surface is made of steel.

The calcination is preferably carried out in an oxidizing atmosphere, at a temperature preferably above 800° C. and preferably below 1700° C., the maximum temperature reached during the calcination preferably being maintained for a period of at least 30 minutes, preferably at least 1 hour, preferably at least 2 hours.

Preferably, step f) is carried out at atmospheric pressure.

Preferably, step f) is carried out in air.

Advantageously, carrying out a step f) makes it possible to further improve the efficacy and/or the energy efficiency of the fused grains according to the invention.

In a first embodiment, in particular when the fused grains are intended for machining a hard steel, in particular after having been integrated into an abrasive tool, the process comprises a calcination step f) preferably in an oxidizing atmosphere, preferably in air, at a temperature preferably above 800° C., preferably above 900° C., and below or equal to 1280° C., preferably below 1200° C., preferably below 1150° C., preferably below 1100° C., the maximum temperature reached during the calcination preferably being maintained for a period of at least 30 minutes, preferably at least 1 hour, preferably at least 2 hours.

In a second embodiment, in particular when the fused grains are intended for machining a stainless steel, in particular after having been integrated into an abrasive tool, the process comprises a calcination step f) in an oxidizing atmosphere, preferably in air, preferably at a temperature above 1280°° C., preferably above 1300° C., and preferably below 1700° C., preferably below 1600° C., preferably below 1500° C., the maximum temperature reached during the calcination preferably being maintained for a period of at least 30 minutes, preferably at least 1 hour, preferably at least 2 hours.

### Process for Manufacturing an Abrasive Tool According to the Invention

The processes for manufacturing abrasive tools are well known and can be used to manufacture an abrasive tool according to the invention.

The abrasive tools may in particular be formed by agglomerating grains according to the invention by means of a binder, in particular in the form of a grinding wheel, for example by pressing, or be formed by attaching grains according to the invention to a backing, for example a belt or a disk, by means of a binder.

The binder can be inorganic, in particular a glass (for example, a binder consisting of oxides, substantially consisting of silicate(s) can be used) or organic.

An organic binder is highly suitable. The binder may in particular be a thermosetting resin. It is preferably chosen from the group consisting of phenolic, epoxy, acrylate, polyester, polyamide, polybenzimidazole, polyurethane, phenoxy, phenol-furfural, aniline-formaldehyde, urea-formaldehyde, cresol-aldehyde, resorcinol-aldehyde, urea-aldehyde or melamine-formaldehyde resins, and mixtures thereof.

The binder may also incorporate organic or inorganic fillers, such as hydrated inorganic fillers (for example aluminum trihydrate or boehmite) or nonhydrated inorganic fillers (for example molybdenum oxide), cryolite, a halogen, fluorspar, iron sulfide, zinc sulfide, magnesia, silicon carbide, silicon chloride, potassium chloride, manganese dichloride, potassium or zinc fluoroborate, potassium fluoroaluminate, calcium oxide, potassium sulfate, a copolymer of vinylidene chloride and vinyl chloride, polyvinylidene chloride, polyvinyl chloride, and mixtures thereof. The binder may also contain reinforcing fibers, such as glass fibers.

Conventionally, a mixture of grains according to the invention is mixed with a binder, and optionally with organic or inorganic fillers. The mixture obtained, in which the binder conventionally represents between 2% and 60%, preferably between 20% and 40% by volume, is shaped, for example placed in a mold or deposited on a backing. The binder is then activated, for example by heating, to bind the grains to one another and/or with the optional backing. After hardening of the binder and optionally removal from the mold, an abrasive tool according to the invention is obtained.

### EXAMPLES

The following non-limiting examples are given for the purpose of illustrating the invention.

### Measurement Protocols

The following measurement protocols were used to determine certain properties of mixtures of fused grains. They allow an excellent simulation of the real behavior of the grains when they are used for abrasion.

In order to evaluate the abrasive performance of a mixture of grains, a monolayer of one gram of this mixture is applied to a metal grinding wheel with a diameter of 12.7 cm, said grains being bound using a phenolic resin.

The surface of a plate made of 52100 hard steel or of 304L stainless steel, with dimensions of 20.5 cm×7.6 cm×6.0 cm, is then machined with the grinding wheel obtained, under spraying with water, with a reciprocating movement at constant speed, while maintaining a constant cutting depth of 20 μm and a rotational speed of the grinding wheel of 3600 rpm. The total energy developed by the grinding wheel during the machining, Eₜₒₜ, is recorded.

After the grinding wheel has completely worn away, the weight of steel machined (that is to say, the weight of steel removed by the grinding operation), “Mₐ”, and the weight of grinding wheel consumed, “Mₘ”, and the volume of steel removed by the grinding operation “Vₐ” are measured.

To evaluate the efficacy, the ratio S of the weight of steel machined divided by the weight of grains consumed during said machining is calculated conventionally (S=Mₐ/Mₘ).

To evaluate the energy efficiency, the specific energy of machining, Es, equal to the energy required to remove a unit volume of steel is calculated conventionally (Es=Eₜₒₜ/Vₐ).

In order to determine the composition of the fused grains, a bead of a mixture of these grains is manufactured by melting the mixture, then the chemical analysis is carried out by X-ray fluorescence, except for the measurement of the carbon content.

The carbon content of the fused grains is measured using a CS744 model carbon-sulfur analyzer, sold by LECO.

The median size of a powder is measured conventionally using an LA950V2 model laser particle sizer sold by Horiba.

The amount of hydrogen gas released by hot acid etching is determined after hot etching of the grains with a mixture of hydrochloric acid and hydrofluoric acid. The reoxidation of the suboxidized species (suboxides, down to the metal) is thus evaluated.

For this purpose, after magnetic separation, the grains are milled in a milling chamber made of an oxidized material (for example, made of an alumina-zirconia-silica fused material) until a powder is obtained which passes through a sieve with a square mesh having an opening equal to 160 μm. 5 g of said powder are withdrawn and placed in a polypropylene reactor with a volume of 100 cm³. 25 ml of the following acid mixture are then added: (for one liter) 250 ml of 40% HF, 375 ml of 37% HCl and 375 ml of water. After closing the reactor, the etching is carried out at 85° C., in a water bath, for 25 minutes, with regular stirring. After cooling the reactor, approximately 0.5 ml are withdrawn using a syringe through a septum and injected into a gas chromatograph with thermal conductivity detector (with a 5 angström molecular sieve for the separation column, and argon as carrier gas). The result is expressed as volume of gas under normal conditions per 100 g of milled grains.

This release is referred to as “release of hydrogen gas by hot acid etching”.

### Manufacturing Protocol

The mixtures of the examples were prepared from the following raw materials:
alumina powder with a purity greater than 99.6% by weight, comprising the impurities Na₂O, CaO, Fe₂O₃, MgO, TiO₂, SiO₂, and having a median size equal to 80 um;
pigmentary chromium oxide Cr₂O₃ powder sold under the name Bayoxide® C GN-R by Lanxess, having a Cr₂O₃ content of greater than 98.5% by weight;
magnesia powder with a purity greater than 99% by weight, of which more than 85% of the grains, by weight, pass through the mesh of a 45 μm screen.

Reference example 1 (“Ref”), outside the invention, is a mixture of fused grains in accordance with the teaching of WO 2004094554 and serves as a comparison to example 2.

The mixture of grains of example 2 were prepared according to the following manufacturing process, in accordance with the invention:

a) mixing the raw materials so as to form a feedstock, said feedstock comprising 1% by weight of aluminium metal chips and 0.5% by weight of petroleum coke,

b) melting said feedstock in a single-phase electric arc furnace of Héroult type comprising graphite electrodes, with a furnace vessel having a diameter of 0.8 m, a voltage of 125 V, a current of 1800 A and a specific electrical energy supplied of 2 kWh/kg charged,

c) sudden cooling of the molten material by means of a device for casting between thin metal plates, such as that presented in the patent U.S. Pat. No. 3,993,119, so as to obtain a completely solid sheet, constituting a solid mass,

d) milling said solid mass cooled in step c), so as to obtain a mixture of grains,

e) selecting, by screening using a Ro-Tap® sieve shaker, the grains having a size of between 500 and 600 μm.

Table 1 below provides the chemical composition and the results obtained with these mixtures.

The percentage improvement in the S ratio is calculated by the following formula: 100. (ratio S of the mixture of the example considered—ratio S of the mixture of reference example 1)/ratio S of the mixture of reference example 1.

A positive and high value of the percentage of significant improvement in the ratio S is sought, without significant increase of the specific energy, preferably with a reduction in the specific energy (positive value of the percentage reduction in the specific energy Es described below). The inventors consider an improvement of more than 5% in the ratio S to be significant.

Preferably, the ratio S is improved by more than 10%, preferably by more than 15%, preferably by more than 20%, preferably by more than 25%, preferably by more than 30%, preferably by more by 35%.

The percentage reduction in specific energy, Es, is calculated by the following formula:

100. (Es with the mixture of reference example 1−Es with the mixture of the example considered)/Es of the mixture of reference example 1.

A positive and high value of the percentage reduction in the specific energy Es during the test is sought, without degradation, and preferably with an improvement in the ratio S compared to the reference. The inventors consider a reduction of more than 5% in the specific energy Es to be significant. Preferably, the specific energy is reduced by more than 10%, preferably by more than 15% (compared to the reference).

TABLE 1

| | |
|---|---|
| Ex. 1 (Ref) | Ex. 2 |

Chemical analysis, as weight percentages based on the oxides

| Al₂O₃ | Balance to 100% | |
|---|---|---|
| MgO | 3.6 | 4.1 |
| Cr₂O₃ | 0 | 0.4 |
| Elements other than Al₂O₃, MgO and Cr₂O₃ | 0.35 | 0.4 |
| of which Na₂O | 0.25 | 0.25 |
| of which SiO₂ | 0.05 | 0.05 |

Other characteristics

| | | |
|---|---|---|
| Carbon (ppm) based on the weight of grains | 300 | 350 |
| Release of hydrogen gas by hot acid etching, | 245 | 65 |
| as volume of gas per 100 grams of grains | | |
| % of improvement in S | — | 4 |
| % of reduction in Es | — | 12 |

A comparison of reference example 1 and example 2, according to the invention, shows the positive impact of the presence of 0.4% of Cr₂O₃ in a mixture comprising between 2.5% and 5.8% of MgO: for such a Cr₂O₃ content, the ratio S is improved by 4% and the specific energy is reduced by 12% when machining a 52100 hard steel.

Example 2 shows that uncalcined fused grains make it possible to reduce the specific energy, the ratio S not being significantly increased.

The following additional examples were produced. A calcination heat treatment was carried out on a mixture of grains of example 1 and on a mixture of grains of example 2, so as to obtain a mixture of grains according to example 3 and a mixture of grains according to example 4, respectively. Said calcination was carried out in air at 1000° C., the temperature of 1000° C. being maintained for 2 hours, the rate of rise to the temperature of 1000° C. being equal to 300° C./h. The results obtained with these mixtures are provided in table 2 below.

TABLE 2

| | Ex. 3 (Ref) | Ex. 4 |
|---|---|---|
| % of improvement in S | — | 47 |
| % of reduction in Es | — | 45 |

A comparison of reference example 3 and example 4 according to the invention, shows the impact of the presence of 0.4% of Cr₂O₃ and of a calcination step, in particular carried out a temperature equal to 1000°° C.: the ratio S is improved by 47% and the specific energy is reduced by 45% when machining a 52100 hard steel.

The grains of example 4 have a microstructure substantially composed of alumina crystals, said crystals being separated by boundaries, located in which is the element Cr, at least a portion of which is in metallic form, and and substantially all the elements other than Al, Mg, and Cr.

The following additional examples were produced. A calcination heat treatment was carried out on a mixture of grains of example 1 and on a mixture of grains of example 2, so as to obtain a mixture of grains according to example 5 and a mixture of grains according to example 6, respectively. Said calcination was carried out in air at 1400° C., the temperature of 1400° C. being maintained for 2 hours, the rate of rise to the temperature of 1400° C. being equal to 300° C./h.

The results obtained with these mixtures are provided in table 3 below.

TABLE 3

| | Ex. 5 (Ref) | Ex. 6 |
|---|---|---|
| % of improvement in S | — | 32 |
| % of reduction in Es | — | 21 |

A comparison of reference example 5 and example 6, according to the invention, shows the impact of the presence of 0.4% of Cr₂O₃ and of a calcination step, in particular carried out a temperature equal to 1400° C.: the ratio S is improved by 32% and the specific energy is reduced by 21% when machining a 304L stainless steel.

The following additional examples were produced.

The grain mixtures of examples 7 to 11 were prepared according to the following manufacturing process:

a) mixing the raw materials so as to form a feedstock, said feedstock comprising 2% by weight of aluminium metal chips and 0.5% by weight of petroleum coke,

b) melting said feedstock in a single-phase electric arc furnace of Héroult type comprising graphite electrodes, with a furnace vessel having a diameter of 0.8 m, a voltage of 215 V, a current of 1040 A and a specific electrical energy supplied of 3 kWh/kg charged,

c) sudden cooling of the molten material by means of a device for casting between thin metal plates, such as that presented in the patent U.S. Pat. No. 3,993,119, so as to obtain a completely solid sheet, constituting a solid mass,

d) milling said solid mass cooled in step c), so as to obtain a mixture of grains,

e) selecting, by screening using a Ro-Tap® sieve shaker, the grains having a size of between 500 and 600 μm.

Table 4 below provides the chemical composition of these mixtures.

TABLE 4

| | | | | |
|---|---|---|---|---|
| Ex. 7 | Ex. 8 | Ex. 9(*) | Ex. 10 | Ex. 11(*) |

Chemical analysis, as weight percentages based on the oxides

| Al₂O₃ | Balance to 100% | | | | |
|---|---|---|---|---|---|
| MgO | 3.1 | 3.5 | 3.6 | 5.2 | 7 |
| Cr₂O₃ | 1 | 4.1 | 5 | 2 | 1.7 |
| Oxides other than Al₂O₃, | 0.9 | 0.4 | 1.4 | 0.4 | 0.6 |
| MgO and Cr₂O₃ | | | | | |
| of which Na₂O | <0.05 | <0.05 | <0.05 | <0.05 | <0.05 |
| of which SiO₂ | <0.03 | <0.03 | <0.03 | <0.05 | <0.03 |
| Carbon (ppm) based on | 50 | n.d. | 60 | 30 | 50 |
| the weight of grains | | | | | |

(*)outside the invention
n.d.: not determined

Table 5 below provides the results obtained on the mixtures of grains of reference example 1 and examples 2, 7, 8 and 9, with a reminder of the contents of MgO and Cr₂O₃ for each of the examples.

TABLE 5

| | Ex. 1 (ref) | Ex. 2 | Ex. 7 | Ex. 8 | Ex. 9(*) |
|---|---|---|---|---|---|
| MgO as percentages by | 3.6 | 4.1 | 3.1 | 3.5 | 3.6 |
| weight based on the oxides | | | | | |
| Cr₂O₃ as percentages by | 0 | 0.4 | 1 | 4.1 | 5 |
| weight based on the oxides | | | | | |
| % improvement in S when | — | 4 | 31 | 19 | 25 |
| machining a 52100 hard steel | | | | | |
| % reduction in Es when | — | 12 | 6 | 15 | −17 |
| machining a 52100 hard steel | | | | | |

(*)outside the invention

A comparison of reference example 1 and examples 2, 7 and 8 according to the invention and 9 outside of the invention shows the impact of the presence of Cr₂O₃ in a mixture comprising between 3.1% and 4.1% of MgO:
for Cr₂O₃ contents of between 0.4% and 4.1%, the ratio S is improved by 4%, 31% and 19% for examples 2, 7 and 8, respectively, and the specific energy is reduced by 12%, 6% and 15% for examples 2, 7 and 8, respectively,
for example 9 having a Cr₂O₃ content equal to 5%, the ratio S is improved by 25% but the specific energy increases by 17%.

A comparison of reference example 1 and example 7 according to the invention, having an MgO content equal to 3.6% and 3.1%, respectively, shows that the grains of example 7 have a ratio S improved by 31% and a reduction in specific energy of 6% compared to the grains of reference example 1.

Table 6 below provides the results obtained on the mixtures of grains of reference example 1 and examples 10 and 11, with a reminder of the contents of MgO and Cr₂O₃ for each of the examples.

TABLE 6

| | Ex. 1 (ref) | Ex. 10 | Ex. 11(*) |
|---|---|---|---|
| MgO, as percentages by | 3.6 | 5.2 | 7 |
| weight based on the oxides | | | |
| Cr₂O₃, as percentages by | 0 | 2 | 1.7 |
| weight based on the oxides | | | |
| % improvement in S when | — | 9 | −34 |
| machining a 304L stainless steel | | | |
| % reduction in Es when | — | 6 | 7 |
| machining a 304L stainless steel | | | |

(*)outside the invention

A comparison of reference example 1 and example 10 according to the invention, and example 11 outside the invention, shows that the grains of example 11 having an MgO content equal to 7% and a Cr₂O₃ content equal to 1.7% have a ratio S reduced by 34% and a percentage reduction in the specific energy equal to 7% compared to the grains of the reference, unlike the grains of example 10 having an MgO content equal to 5.2% and a Cr₂O₃ content equal to 2%, which have a ratio S improved by 9% and a percentage reduction in the specific energy equal to 6% compared to the grains of the reference.

As is now clearly apparent, the invention provides a mixture of alumina-based fused grains having better efficacy and energy efficiency than those of known alumina-based grains.

Of course, the present invention is not limited to the embodiments described which are provided by way of illustrating and non-limiting examples.

In particular, the fused grains according to the invention are not limited to particular shapes or dimensions.

1. A fused grai comprising the following chemical analysis, as weight percentages based on the oxides:
MgO: 2.5% to 5.8%;
Cr₂O₃:0.2% to 4.5%;
oxides other than MgO, Cr₂O₃ and Al₂O₃: ≤1.5%; and
Al₂O₃: balance to 100%.

2. The fused grain as claimed in the preceding claim 1, wherein:
Cr₂O₃≤4.0%, and/or
the content of oxides other than MgO, Cr₂O₃ and Al₂O₃ is less than 1.3%.

3. The fused grain as claimed in the preceding claim 1, wherein:
MgO: 2.5% to 5.5%;
Cr₂O₃:0.2% to 3%;
oxides other than MgO, Cr₂O₃ and Al₂O₃: ≤1%; and
Al₂O₃: balance to 100%.

4. The fused grain as claimed in claim 1, wherein:
MgO≥2.9%, and/or
MgO≤5.5%, and/or
Cr₂O₃≥0.3%, and/or
the content of oxide compounds is greater than 96%, as weight percentages based on the weight of the fused grain.

5. The fused grain as claimed in the preceding claim 4, wherein:
MgO≥3.1%, and/or
MgO≤5.2%, and/or
Cr₂O₃≥0.4%, and/or
the content of oxides other than MgO, Cr₂O₃ and Al₂O₃ is less than 1.0%, and/or
the content of oxide compounds is greater than 97%, as weight percentages based on the weight of the fused grain.

6. The fused grain as claimed in claim 5, wherein:
MgO≥3.5%, and/or
MgO≤5.1%, and/or
Cr₂O₃≥0.7%, and/or
Cr₂O₃≤3.0%, and/or
the content of oxides other than MgO, Cr₂O₃ and Al₂O₃ is less than 0.5%.

7. The fused grain as claimed in the preceding claim 6, wherein:
MgO≥4.0%, and/or
MgO≤5.0%, and/or
Cr₂O₃≥1.0%, and/or
Cr₂O₃≤2.5%, and/or
the content of oxides other than MgO, Cr₂O₃ and Al₂O₃ is less than 0.4%.

8. The fused grain as claimed in claim 1, wherein:
-Na₂O≤0.3%, as weight percentages based on the oxides, and/or
SiO₂≤0.3%, as weight percentages based on the oxides.

9. The fused grain as claimed in claim 8, wherein:
Na₂O≤0.1%, as weight percentages based on the oxides, and/or
SiO₂≤0.1%, as weight percentages based on the oxides.

10. The fused grain as claimed in claim 1, wherein:
the carbon content is greater than 20 ppm and less than 0.5%, as weight percentages based on the weight of the fused grain, and/or
the release of hydrogen gas by hot acid etching for a mixture consisting of said grains is greater than 15 cm³/100 g and less than 500 cm³/100 g.

11. The fused grain as claimed in claim 10, wherein:
the carbon content is greater than 50 ppm, as weight percentages based on the weight of the fused grain, and/or
the carbon content is less than 0.3%, as weight percentages based on the weight of the fused grain, and/or
the release of hydrogen gas by hot acid etching for a mixture consisting of said grains is greater than 30 cm³/100 g, and/or
the release of hydrogen gas by hot acid etching for a mixture consisting of said grains is less than 400 cm³/100 g.

12. The fused grain as claimed in claim 11, wherein:
the carbon content is less than 0.15%, as weight percentages based on the weight of the fused grain, and/or
the release of hydrogen gas by hot acid etching for a mixture consisting of said grains is greater than 50 cm³/100 g, and/or
the release of hydrogen gas by hot acid etching for a mixture consisting of said grains is less than 300 cm³/100 g.

13. The fused grain as claimed in claim 12, wherein:
the carbon content is less than 0.1%, as weight percentages based on the weight of the fused grain, and/or
the release of hydrogen gas by hot acid etching for a mixture consisting of said grains is less than 200 cm³/100 g.

14. The fused grain as claimed in any one of claim 1, having a microstructure substantially composed of alumina crystals, said crystals being separated by boundaries, located in which is the element Cr, at least partially in metallic form.

15. The fused grain as claimed in claim 14,
such that, for a mixture consisting of said grains, the release of hydrogen gas by hot acid etching, expressed as volume of gas per 100 grams of grains, is greater than 15 cm³/100 g and less than 500 cm³/100 g, and/or
having a carbon content of greater than 20 ppm and less than 0.4%, as weight percentages based on the weight of the fused grain.

16. The fused grain as claimed in claim 1, having a microstructure substantially composed of alumina crystals, said crystals being separated by boundaries, located in which is MgO, preferably substantially entirely in non-stoichiometric and/or stoichiometric MgAl₂O₄ spinel form, and/or in non-stoichiometric and/or stoichiometric MgCr₂O₄ spinel form, at least a portion of the element Cr being inserted into the crystal lattice of the alumina crystals.

17. The fused grain as claimed in claim 16,
such that, for a mixture consisting of said grains, the release of hydrogen gas by hot acid etching, expressed as volume of gas per 100 grams of grains, is less than 15 cm³/100 g, and/or
having a carbon content of less than 500 ppm, as weight percentages based on the weight of the fused grain.

18. A mixture of grains comprising, as weight percentages, more than 80% of fused grains as claimed in claim 1.

19. A process for manufacturing a mixture of fused grains as claimed in claim 18, said process comprising the following successive steps:
a) mixing of raw materials so as to form a feedstock suitable for the manufacture of said mixture of grains,
b) melting said feedstock in a reducing medium until a molten material is obtained,
c) cooling said molten material so as to fully solidify it in less than 3 minutes, and obtain a solid mass.

20. The process as claimed in claim 19, comprising, after step c), a step d) of milling the solid mass obtained at the end of step c), and/or a step e) of particle size selection.

21. The process as claimed in claim 19, not comprising, after step c), or after step d) or after step e), a step f) of calcination at a temperature above 800° C. and below 1700°° C.

22. The process as claimed in claim 19, comprising a step f) of calcination at a temperature above 800° C. and below 1700° C.

23. The process as claimed in claim 22, in which the calcination step f) is carried out in an oxidizing atmosphere.

24. The process as claimed in claim 22, wherein the calcination temperature is below or equal to 1280° C.

25. The process as claimed in claim 22, wherein the calcination temperature is above 1280° C.

26. A process for treating a surface, said process comprising an operation of abrading said surface with a mixture of grains as claimed in claim 18.

27. The process as claimed in claim 26, wherein:
the surface is made of a hard steel and said mixture of grains comprises, as weight percentage, more than 80% of fused grains having a microstructure substantially composed of alumina crystals, said crystals being separated by boundaries, located in which is the element Cr, at least partially in metallic form and/or having been manufactured with the calcination temperature is below or equal to 1280° C., or
the surface is made of a stainless steel and said mixture of grains comprises, as weight percentage, more than 80% of fused grains having a microstructure substantially composed of alumina crystals, said crystals being separated by boundaries, located in which is MgO, preferably substantially entirely in non-stoichiometric and/or stoichiometric MgAl₂O₄ spinel form, and/or in non-stoichiometric and/or stoichiometric MgCr₂O₄ spinel form, at least a portion of the element Cr being inserted into the crystal lattice of the alumina crystals and/or having been manufactured according to a process with the calcination temperature is above 1280°° C.

28. An abrasive tool comprising grains bound by a binder and bonded or deposited on a support, at least one portion of said grains being in accordance with claim 1.

29. An abrasive tool comprising grains bound by a binder and bonded or deposited on a support, comprising more than 80% of grains as claimed in claim 1.

30. The abrasive tool as claimed in claim 28, in the form of a grinding wheel, a belt or a disk.

31. A process for manufacturing an abrasive tool comprising the addition of a binder to grains followed by an agglomeration, or a depositing grains on a backing, at least one portion of said grains, preferably substantially all the grains, being manufactured according to a process as claimed in claim 19.

32. A process for treating a surface, said process comprising an operation of abrading said surface with a mixture of grains manufactured according to a process as claimed in claim 19.

33. The abrasive tool as claimed in claim 29, in the form of a grinding wheel, a belt or a disk.
